(19) United States
(12) Patent Application Publication
(10) Pub. No.: US 2012/0176565 A1
(43) Pub. Date: Jul. 12, 2012

(54) LED LAMP TUBE AND LIQUID CRYSTAL DISPLAY DEVICE

(75) Inventors: Zuo-Shang YU, Fuqing City (CN); Jin-Ching Chuang, New Taipei City (TW)

(73) Assignee: TPV ELECTRONICS (FUJIAN) CO., LTD., Fuqing City (CN)

(21) Appl. No.: 13/346,946

(22) Filed: Jan. 10, 2012

(30) Foreign Application Priority Data
Jan. 12, 2011 (TW) 100101087

(51) Int. Cl. G02F 1/1335; F21V 21/00

(52) U.S. Cl. 349/62; 362/217.14

(57) ABSTRACT

An LED lamp tube includes a plurality of primary light emitting units connected in series. Each of the primary light emitting units includes a plurality of light emitting sub-units connected in parallel. Each of the light emitting sub-units includes at least one light emitting diode. A liquid crystal display device includes the LED lamp tube, a drive circuit, an optical module and a liquid crystal layer.

### CROSS-REFERENCE TO RELATED APPLICATION

This application claims priority to Taiwanese Application No. 100101087, filed on Jan. 12, 2011.

### BACKGROUND OF THE INVENTION

1. Field of the Invention

The invention relates to a lamp tube and a display device, and more particularly to alight emitting diode (LED) lamp tube and a liquid crystal display device.

2. Description of the Related Art

FIG. 1 and FIG. 2 illustrate a conventional LED lamp tube 1 applied to a liquid crystal display device 2. The liquid crystal display 2 includes a liquid crystal layer (not shown), an optical module 21 for varying distribution of light, and a drive circuit 22. The drive circuit 22 includes a power supply output 221 and four feedback control terminals 222.

The LED lamp tube 1 includes a power supply input terminal 11, four output terminals 12, four light emitting units 13, and a printed circuit board (PCB) 14. Each light emitting unit 13 includes twenty two LEDs 131 connected in series between the power supply input terminal 11 and a corresponding one of the output terminals 12. The LEDs 131 of the light emitting units 13 are arranged along an X direction on the PCB 14, as best shown in FIG. 2. The power supply input terminal 11 is electrically connected to the power supply output terminal 221 of the drive circuit 22, and the output terminals 12 are respectively and electrically connected to the feedback control terminals 222 of the drive circuit 22.

Each light emitting unit 13 receives current from the power supply output terminal 221 of the drive circuit 22, and emits light with an intensity that is determined according to magnitude of the drive current flowing therethrough. The magnitude of the current flowing through each light emitting unit 13 is controlled through the respective feedback control terminal 222 of the drive circuit 22. Light emitted from the LED lamp tube 1 reaches the liquid crystal layer through the optical module 21. A surface of the optical module 21 facing the liquid crystal layer can be divided into four backlight zones 211˜214 respectively corresponding to the light emitting units 13, as best shown in FIG. 2.

If the drive circuit 22 is not designed to equalize the drive currents, the light emitting unit 13 with a higher forward bias voltage (i.e., the measured voltage is higher with the same test current flowing therethrough) will receive a smaller drive current, and the light emitting unit 13 thus emits light with lower intensity (relative to the intensity of light emitted from other light emitting units 13).

If the intensity of light emitted from the light emitting unit 13 corresponding to the backlight zone 211 is lower, because the left side of the backlight zone 211 is relatively far from the backlight zones 212˜214, it is difficult to rely on the light with higher intensity emitted from the light emitting units 13 corresponding to the backlight zones 212˜214 in order to supplement light at the left side of the backlight zone 211 even if the light diffuses through the optical module 21. Accordingly, the left side of the backlight zone 211 would be darker than the backlight zones 212˜214. On the other hand, the light emitting unit 13 with a lower forward bias voltage (i.e., the measured voltage is lower with the same test current flowing therethrough) will receive a larger drive current, and the light emitting unit 13 thus emits light with higher intensity.

Assuming the intensity of light emitted from the light emitting unit 13 corresponding to the backlight zone 211 is higher, because the backlight zone 211 is relatively far from the right side of the backlight zone 212 and from the backlight zones 213 and 214, it is difficult to rely on the light with higher intensity emitted from the light emitting unit 13 corresponding to the backlight zone 211 in order to supplement light at the right side of the backlight zone 212 and the backlight zones 213 and 214 even if the light diffuses through the optical module 21. Accordingly, the backlight zone 211 would be brighter than the right side of the backlight zone 212 and the backlight zones 213 and 214.

Therefore, the drive circuit 22 needs a current equalization function to solve the above issues of non-uniform intensity, but this leads to a higher cost of the drive circuit 22.

If the drive circuit 22 has a current equalization function but has no short circuit protection function, when anyone of the LEDs 131 short-circuits due to damage, the working voltage of the light emitting unit 13 to which the LED 131 belongs will be reduced, leading to an increase in the voltage of the feedback control terminal 222 of the drive circuit 22 electrically connected to the light emitting unit 13. The feedback control terminals 222 are usually electrically connected to the drain or collector of transistors of an internal current equalization circuit (not shown) of the drive circuit 22, and the higher voltage would cause temperature of the transistors of the current equalization circuit of the drive circuit 22 to rise because of increased power dissipation.

Therefore, the drive circuit 22 additionally needs a short circuit protection function to avoid damage to transistors of a current equalization circuit due to overheating, but this increases the cost of the drive circuit 22 further.

Moreover, assuming the light emitting unit 13 corresponding to the backlight zone 211 has at least one LED 131 that short-circuits due to damage such that the drive circuit 22 activates the short circuit protection function to turn off the light emitting unit 13 corresponding to the backlight zone 211 (that is, the light emitting unit 13 corresponding to the backlight zone 211 is turned off and does not emit light), the backlight zone 211 will be seriously dark compared to the backlight zones 212˜214.

If anyone of the LEDs 131 open-circuits due to damage, the other LEDs 131 connected in series to the damaged LED 131 will not work either, and the light emitting unit 13 to which the damaged LED 131 belongs will not emit light. Assuming one of the LEDs 131 of the light emitting unit 13 corresponding to the backlight zone 211 open-circuits due to damage, the backlight zone 211 will be seriously dark compared to the backlight zones 212˜214.

### SUMMARY OF THE INVENTION

Therefore, an object of the present invention is to provide an LED lamp tube that can overcome the above drawbacks of the prior art.

According to one aspect of the present invention, an LED lamp tube comprises a plurality of primary light emitting units connected in series. Each of the primary light emitting units includes a plurality of light emitting sub-units connected in parallel. Each of the light emitting sub-units includes at least one light emitting diode.

Another object of the present invention is to provide a liquid crystal display device that can overcome the above drawbacks of the prior art.

According to another aspect of the present invention, a liquid crystal display device comprises an LED lamp tube, a drive circuit, an optical module and a liquid crystal layer.

The LED lamp tube includes a plurality of primary light emitting units connected in series. Each of the primary light emitting units includes a plurality of light emitting sub-units connected in parallel. Each of the light emitting sub-units includes at least one light emitting diode.

The drive circuit is connected electrically to and operable to provide a drive current to the LED lamp tube such that the LED lamp tube generates a light output with an intensity that corresponds to magnitude of the drive current.

The optical module is disposed to receive the light output of the LED lamp tube and to vary distribution of light passing through the optical module.

The liquid crystal layer is disposed to receive the light passing through the optical module.

### BRIEF DESCRIPTION OF THE DRAWINGS

Other features and advantages of the present invention will become apparent in the following detailed description of the preferred embodiment with reference to the accompanying drawings, of which:

FIG. 1 is a circuit diagram showing a conventional LED lamp tube;

FIG. 2 is a schematic diagram showing the conventional LED lamp tube applied to a liquid crystal display device;

FIG. 3 is a schematic side view showing the preferred embodimentofaliquid crystal display device according to the present invention;

FIG. 4 is a circuit diagram showing an LED lamp tube of the preferred embodiment;

FIG. 5 is a circuit diagram showing a modified LED lamp tube of the preferred embodiment; and

FIG. 6 is a schematic diagram of the preferred embodiment.

### DETAILED DESCRIPTION OF THE PREFERRED EMBODIMENT

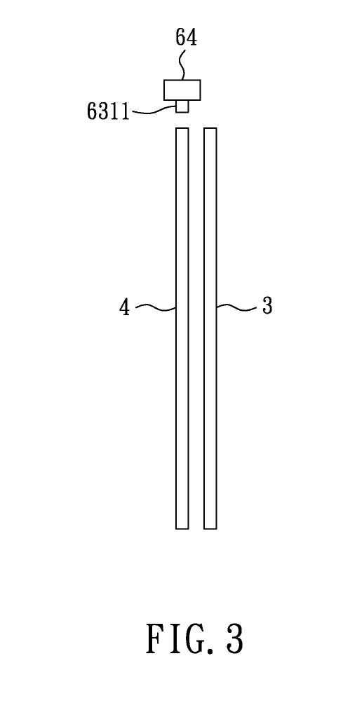

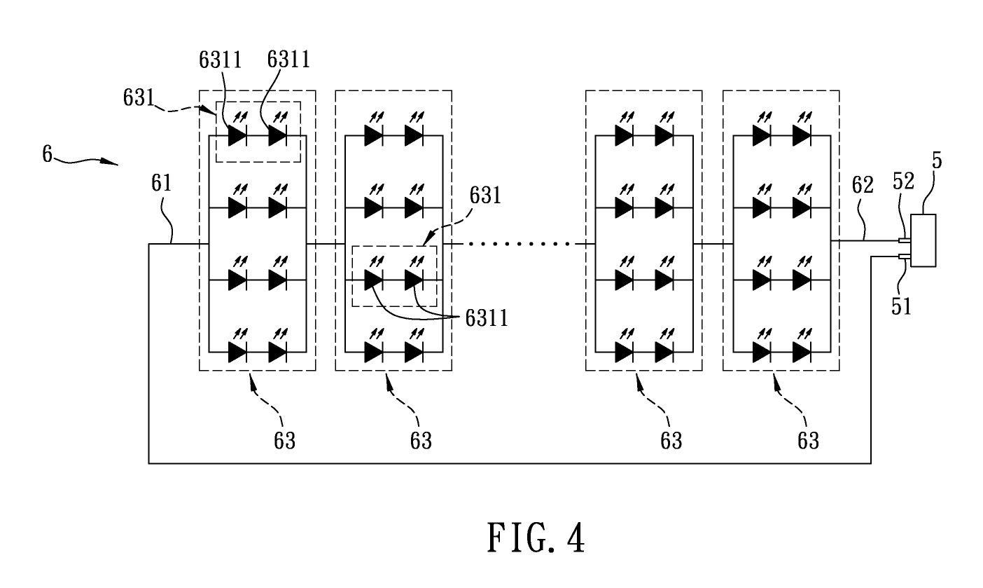

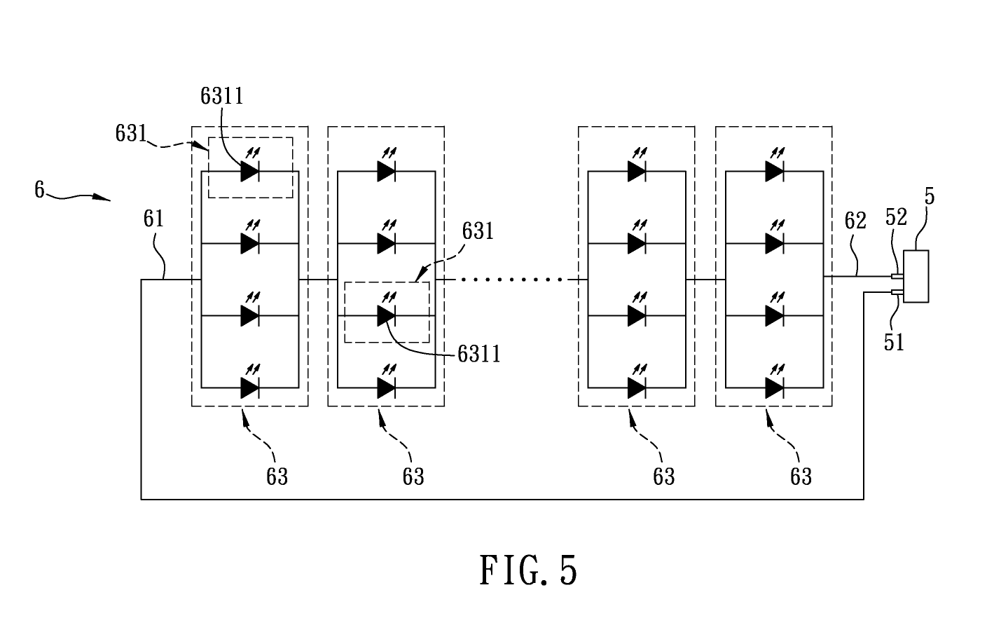

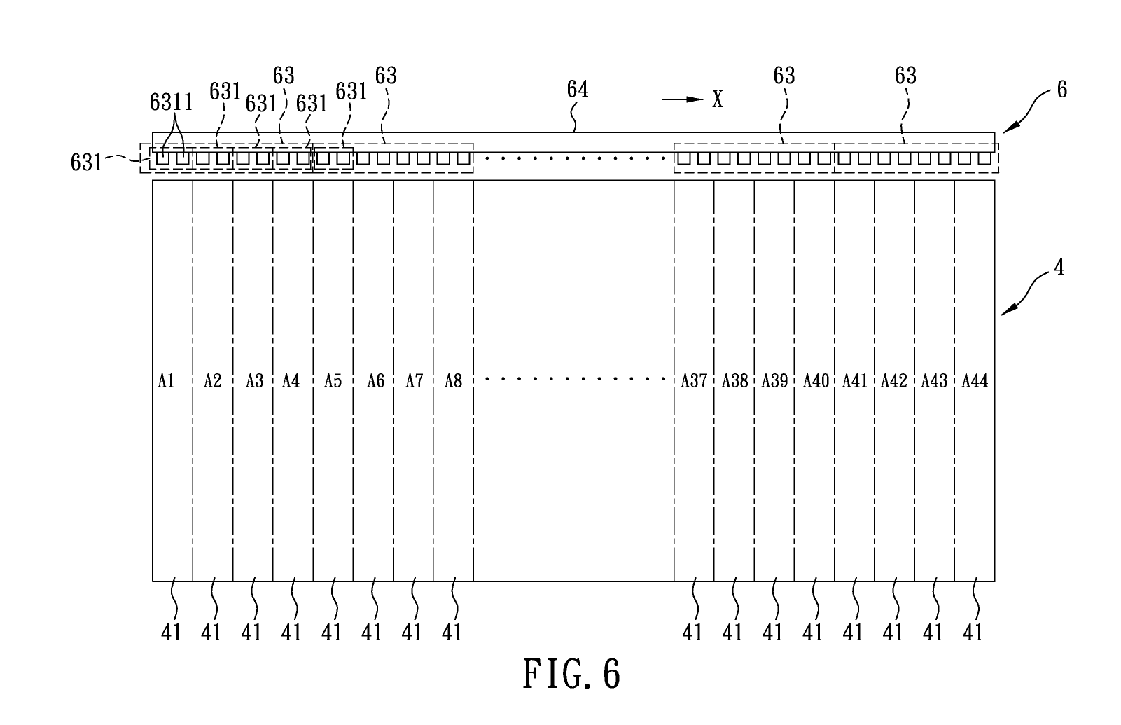

Referring to FIG. 3 to FIG. 5, the preferred embodiment of the liquid crystal display device according to this invention is shown to include a liquid crystal layer 3, an optical module 4, a drive circuit 5, and an LED lamp tube 6. The optical module 4 is disposed to vary distribution of light so that the distribution of light outputted thereby is more uniform compared to light received thereby. The drive circuit 5 is configured to provide a constant drive current for normal operation of the LED lamp tube 6, and includes a power supply output terminal 51 for outputting the drive current and a feedback control terminal 52 for maintaining the constant drive current. The LED lamp tube 6 is electrically connected to the drive circuit 5 to receive the drive current therefrom, and emits light with an intensity corresponding to magnitude of the drive current. Light emitted from the LED lamp tube 6 passes through the optical module 4 before reaching the liquid crystal layer 3. The LED lamp tube 6 includes a power supply input terminal 61 electrically connected to the power supply output terminal 51 of the drive circuit 5, an output terminal 62 electrically connected to the feedback control terminal 52 of the drive circuit 5, a plurality of primary light emitting units 63 connected in series between the power supply input terminal 61 and the output terminal 62, and a printed circuit board (PCB) 64. Each primary light emitting unit 63 includes a plurality of light emitting sub-units 631 connected in parallel. The light emitting sub-units 631 are sequentially arranged on the PCB 64 along an X direction (see FIG. 6), and each light emitting sub-unit 631 includes at least one LED 6311. FIG. 4 shows an embodiment in which each primary light emitting unit 63 includes four light emitting sub-units 631, and each light emitting sub-unit 631 has two LEDs 6311. FIG. 5 shows another embodiment in which each primary light emitting unit 63 includes four light emitting sub-units 631, and each light emitting sub-unit 631 has one LED 6311.

Referring to FIG. 3, FIG. 4 and FIG. 6, to facilitate explanation, the LED lamp tube 6 of an example of the preferred embodiment includes eleven primary light emitting units 63, each primary light emitting unit 63 includes four light emitting sub-units 631, and each light emitting sub-unit 631 has two LEDs 6311.

As shown in FIG. 6, a side of the optical module 4 facing the liquid crystal layer 3 is divided into forty four backlight zones 41 respectively corresponding to the light emitting sub-units 631 and having equal areas. The backlight zones 41 are sequentially marked as A1˜A44.

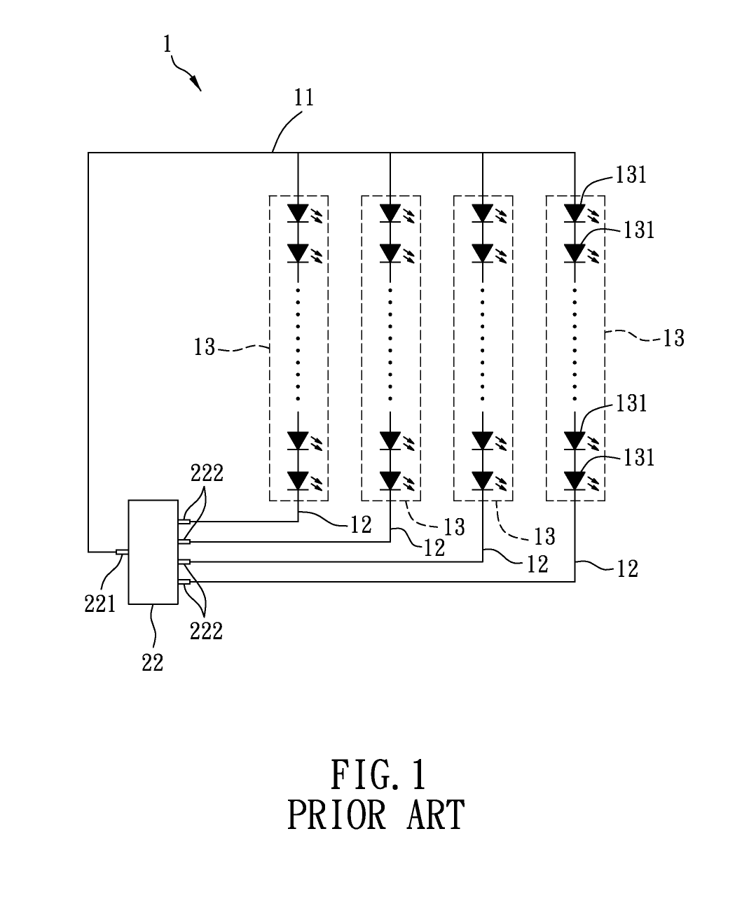

Because the LED lamp tube 6 only includes one power supply input terminal 61 and one output terminal 62, the drive circuit 5 only needs to provide a constant drive current for normal operation of the LED lamp tube 6, and does not require a current equalization function. The LED lamp tube 6 with the single-input-single-output structure simplifies requisite circuit functions of the drive circuit 5 and reduces costs. Hence, compared to the conventional LED lamp tube 1 with the drive circuit 22 shown in FIG. 1, the LED lamp tube 6 of this embodiment has relatively lower design cost.

Moreover, because the drive circuit 5 only needs to provide a constant drive current for normal operation of the LED lamp tube 6, the issue of non-uniform intensity may be resolved through arrangement of the electrical connections among the LEDs 6311.

After dividing the side of the optical module 4 facing the liquid crystal layer 3 into forty four backlight zones 41, because the centers of two adjacent backlight zones 41 are relatively close to each other, the light from adjacent light emitting sub-units 631 may easily supplement each other after diffusing through the optical module 4, thus making luminance ofall backlight zones A1˜A44 more uniform.

Assuming the intensity of the light emitted from the light emitting sub-unit 631 corresponding to the backlight zone A1 is lower, because the left side of the backlight zone A1 is close to the backlight zone A2, and the left side of the backlight zone A2 is close to the backlight zone A3, the light emitted from the light emitting sub-unit 631 corresponding to the backlight zone A3 may easily supplement the light at the left side of the backlight zone A2, and the light emitted from the light emitting sub-unit 631 corresponding to the backlight zone A2 may easily supplement the light at the left side of the backlight zone A1, so that the backlight zones A1, A2 and A3 have luminance values that are close to each other.

If anyone of the LEDs 6311 open-circuits due to damage, the light emitting sub-unit 631 to which the damaged LED 6311 belongs will not emit light. Assuming the light emitting sub-unit 631 corresponding to the backlight zone A1 does not emit light, because centers of two adjacent backlight zones 41 are close to each other after dividing the side of the optical module 4 facing the liquid crystal layer 3 into forty four backlight zones 41 with equal areas, the light from the adjacent light emitting sub-units 631 may easily supplement each other after diffusing through the optical module 4. For example, light emitted from the light emitting sub-unit 631 corresponding to the backlight zone A4 may easily supplement light emitted from the light emitting sub-units 631 corresponding to the backlight zones A3 and A5, light emitted from the light emitting sub-unit 631 corresponding to the backlight zone A3 may easily supplement light emitted from the light emitting sub-units 631 corresponding to the backlight zones A2 and A4, and light emitted from the light emitting sub-unit 631 corresponding to the backlight zone A2 may easily supplement the backlight zone A1. Although the luminance of the backlight zone A1 has a small difference compared to those of the backlight zones A2˜A44, such difference is generally acceptable to users.

If all LEDs 6311 of any one of the light emitting sub-units 631 short-circuit due to damage, the primary light emitting unit 63 to which the damaged LEDs 6311 belong will not emit light. Because the drive current provided by the drive circuit 5 for normal operation of the LED lamp tube 6 is constant, voltage of the power supply input terminal 61 of the LED lamp tube 6 will be lowered, and the other primary light emitting units 63 can still continue to work normally.

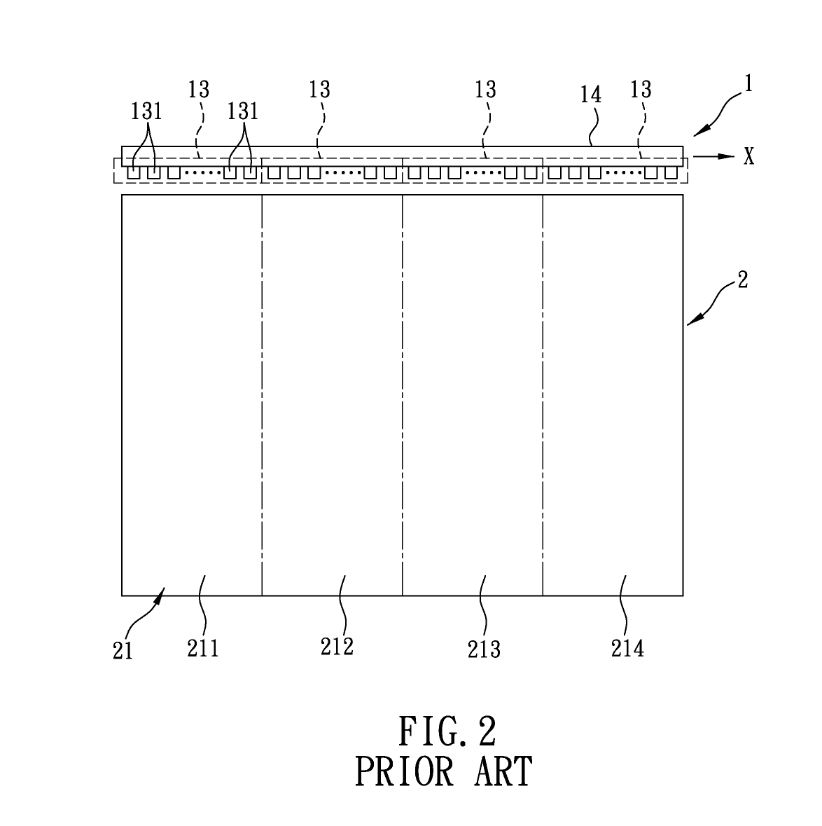

By comparing FIG. 2 and FIG. 6, if an LED 131 of the light emitting unit 13 corresponding to the backlight zone 211 in FIG. 2 experiences short-circuit and is protected by the drive circuit 22, the remaining LEDs 131 of the light emitting 13 will not work and not emit light. Since the backlight zone 211 occupies a quarter of the total area of all backlight zones 211˜214, the backlight zone 211 is not able to get adequate light supplement from the light emitting unit 13 corresponding to the adjacent backlight zone 212 because of the large area thereof, and the left side of the backlight zone 211 will thus be much darker compared to the other backlight zones 212˜214. If the LEDs 6311 of any one of the light emitting sub-units 631 (assumed to correspond to the backlight zone A1) in FIG. 6 all experience short-circuit due to damage, the primary light emitting unit 63 to which the damaged LEDs 6311 belong will not emit light, but the area of the backlight zones A1˜A4 corresponding to the primary light emitting unit 63 which does not emit light only occupies one-eleventh of the total area of all backlight zones A1˜A44 (which is much smaller than a quarter). Because the backlight zone 41 in FIG. 6 is much smaller than the backlight zone 211 in FIG. 2, after the backlight zones A1˜A4 are supplemented with the light of the primary light emitting units 63 corresponding to the right adjacent other backlight zones 41, although luminance of the backlight zones A1˜A4 may not be as high as those of the backlight zones A5˜A44, there is an improvement compared to the condition in FIG. 2 where the backlight zone 211 in the LED lamp tube 1 is seriously dark since the light emitting unit 13 corresponding thereto does not emit light when an LED 131 of the light emitting unit 13 corresponding to the backlight zone 211 experiences short-circuit and is protected by the drive circuit 22.

It is worthwhile to note that, as the number of the light emitting sub-units 631 increases, the area of the backlight zone 41 corresponding to each light emitting sub-unit 631 becomes smaller, and the effect of supplementing luminance among adjacent backlight zones 41 becomes better. While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A light emitting diode (LED) lamp tube comprising a plurality of primary light emitting units connected in series, each of said primary light emitting units including a plurality of light emitting sub-units connected in parallel, each of said light emitting sub-units including at least one light emitting diode.

2. The LED lamp tube as claimed in claim 1, wherein each of said light-emitting sub-units includes a plurality of said light emitting diodes connected in series.

3. A liquid crystal display device comprising:
a light emitting diode (LED) lamp tube including a plurality of primary light emitting units connected in series, each of said primary light emitting units including a plurality of light emitting sub-units connected in parallel, each of said light emitting sub-units including at least one light emitting diode;
a drive circuit connected electrically to and operable to provide a drive current to said LED lamp tube such that said LED lamp tube generates a light output with an intensity that corresponds to magnitude of the drive current;
an optical module disposed to receive the light output of said LED lamp tube and to vary distribution of light passing through said optical module; and
a liquid crystal layer disposed to receive the light passing through said optical module.

4. The liquid crystal display device as claimed in claim 3, wherein each of said light-emitting sub-units includes a plurality of said light emitting diodes connected in series.
